(19) United States
(12) Patent Application Publication
(10) Pub. No.: US 2025/0094786 A1
(43) Pub. Date: Mar. 20, 2025

(54) GENERATIVE ARTIFICIAL INTELLIGENCE (AI) TRAINING AND AI-ASSISTED DECISIONING

(71) Applicant: State Farm Mutual Automobile Insurance Company, Bloomington, IL (US)

(72) Inventors: Aaron Williams, Congerville, IL (US); Kenneth D. Sanders, Bloomington, IL (US)

(21) Appl. No.: 18/788,606

(22) Filed: Jul. 30, 2024

Related U.S. Application Data
(60) Provisional application No. 63/584,041, filed on Sep. 20, 2023.

(51) Int. Cl. G06N 3/0475; G06F 16/903; G06N 3/08

(52) U.S. Cl. CPC G06N 3/0475; G06F 16/90335; G06N 3/08

(57) ABSTRACT

A computer system is configured to store historical data identifying a plurality of events and corresponding outcomes, train an artificial intelligence (AI) model using the historical data generate a trained AI model, and generate a user interface enabling access to functionality of the trained AI model at a remote computing device. The computer system is also configured to receive, via the user interface, an operational request including initial input data, identify additional data missing from the operational request, retrieve, in response to a plurality of queries and responses through the user interface, the additional data, and execute the trained AI model using the initial input data and the additional data, wherein a model output from the trained AI model includes an operational response. The computer system is further configured to automatically initiate the operational response, including transmitting a notification and executing one or more functions responsive to the operational request.

### CROSS-REFERENCE TO RELATED APPLICATION

This application claims the benefit of priority to U.S. Prov. Pat. App. No. 63/584,041, filed Sep. 20, 2023, which is incorporated by reference herein.

### FIELD OF THE DISCLOSURE

The present disclosure relates to artificial intelligence (AI) and, more particularly, to a network-based system and method for training an AI model and executing the model in response to user queries.

### BACKGROUND

When an event happens and a response to that event is required, there is a lot of data that needs to be analyzed. However, in many cases, the data comes from a plurality of sources, and may be stored in a plurality of storage locations and storage types. Furthermore, processes for analyzing such disparate data may take time to learn and master, and may often not be suitable for simple automation.

Conventional techniques may also make it more difficult to determine if all of the needed data has been provided when analysis is ready to occur. In some of these cases, it may take days to weeks to collect all of the data to be analyzed. During this time, data may be lost and/or misplaced. Conventional techniques may also be ineffective, inefficient, cumbersome, and/or have other drawbacks as well.

### BRIEF SUMMARY

The present embodiments may relate to systems and methods for leveraging artificial intelligence (AI) techniques for data processing and analyzing in response to an event. In particular, networked systems for training an AI model on historical data and for subsequently executing the trained AI model on newly input data are described herein. Likely or recommended outcomes are provided and may be automatically implemented in at least some cases. The events and related outcomes are then stored and used for re-training the AI model for continuous learning. Such a computer system, as described herein, may include an Automated Claims Processing (ACP) computer device that is in communication with user computing devices and a plurality of data sources, including sensors and smart devices.

In one aspect, a computer system for data processing and automated claims processing may be provided. The computer system may include, or be configured to work with, one or more local or remote processors, transceivers, sensors, servers, memory units, mobile devices, wearables, smart devices, smart glasses, augmented reality (AR) glasses or headsets, virtual reality (VR) glasses or headsets, extended or mixed reality (MR) glasses or headsets, voice bots, chat bots, ChatGPT bots, ChatGPT-based bots, and/or other electronic or electrical components, which may be in wired or wireless communication with one another. For example, in one instance, the computer system may include at least one processor in communication with at least one memory device. The at least one processor may be programmed to: (i) store historical data in the at least one memory device, the historical data identifying a plurality of events, corresponding aspects associated with the events, and corresponding outcomes associated with the events; (ii) train an artificial intelligence (AI) model using the historical data as a training set to generate a trained AI model that, when executed using unmodelled input data, is configured to output one or more predicted outcomes associated with the input data; (iii) generate a user interface enabling access to functionality of the trained AI model at one or more remote computing devices; (iv) receive, via the user interface executed at a first remote computing device, an operational request including initial input data associated with a subject event; (v) identify additional data missing from the operational request; (vi) retrieve, in response to a plurality of queries and responses through the user interface, the additional data; (vii) execute the trained AI model using the initial input data and the additional data, wherein a model output from the trained AI model includes an operational response to the operational request associated with the subject event; and/or (viii) automatically initiate the operational response, including transmitting a notification of the operational response via the user interface and executing one or more functions responsive to the operational request using at least one of the initial input, the additional data, and the model output. The computer system may have additional, less, or alternate functionality, including that discussed elsewhere herein.

In another aspect, a computer-implemented method for training and executing an AI model may be provided. The method may be implemented using a computer system including at least one processor in communication with at least one memory device. The method may include: (i) storing historical data in the at least one memory device, the historical data identifying a plurality of events, corresponding aspects associated with the events, and corresponding outcomes associated with the events; (ii) training an AI model using the historical data as a training set to generate a trained AI model that, when executed using unmodelled input data, is configured to output one or more predicted outcomes associated with the input data; (iii) generating a user interface enabling access to functionality of the trained AI model at one or more remote computing devices; (iv) receiving, via the user interface executed at a first remote computing device, an operational request including initial input data associated with a subject event; (v) identifying additional data missing from the operational request; (vi) retrieving, in response to a plurality of queries and responses through the user interface, the additional data; (vii) executing the trained AI model using the initial input data and the additional data, wherein a model output from the trained AI model includes an operational response to the operational request associated with the subject event; and/or (viii) automatically initiating the operational response, including transmitting a notification of the operational response via the user interface and executing one or more functions responsive to the operational request using at least one of the initial input, the additional data, and the model output. The method may have additional, fewer, or alternate steps, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of a first exemplary process for training and executing a generative AI model in accordance with one embodiment of this disclosure;

FIG. 2 illustrates a flow chart of a second exemplary process for training and executing a generative AI model in accordance with one embodiment of this disclosure;

FIG. 3 illustrates a simplified block diagram of an exemplary computer system for implementing the processes shown in FIGS. 1 and 2;

FIG. 4 is a schematic diagram of an exemplary automated claim processing (ACP) server computing device that may be used with the system shown in FIG. 3;

FIG. 5 illustrates an exemplary configuration of a server computer device that may be used with the system shown in FIG. 3;

FIG. 6 illustrates an exemplary configuration of a client computer device that may be used with the system shown in FIG. 3; and

FIG. 7 is a flow chart of a method for training and executing an AI model, using the computer system shown in FIG. 3.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, the training and execution of generative artificial intelligence (AI) models for various applications, and, more particularly, to a network-based system and method for training an AI model using historical insurance-related data and executing the trained AI model using unmodelled input data associated with a claim to receive a predicted outcome. An exemplary computer system, as described herein, may include an Automated Claim Processing (ACP) computer device that is in communication with one or more memories or databases, sensors, third-party servers, and the like. The ACP computer device and its functionality are accessible to remote user computing devices via a user interface enabling interaction between users and the ACP computer device. The ACP computer device is programmed to perform various processes as described herein, and may be referred to as an ACP server, ACP server computing device, and the like.

In general, a user, such as a policyholder, has an insurance policy with an insurance provider or other entity. The insurance policy offers some amount of coverage related to covered property, which may include residential or commercial property (such as homes, businesses, other building types, vehicles, objects, etc.). When an event occurs, such as damage to or loss of the covered property, the user may interact with the insurance provider or an agent thereof to initiate an insurance claim, also referred to herein as a claim, generally.

In the exemplary embodiment, the ACP computer device may be programmed to train an AI model (as described in greater detail herein) using a plurality of data sources representative of historical claim events, details surrounding the events, and the corresponding outcomes (e.g., whether a claim was approved or denied, an amount of funds associated with an approved claim, etc.). As a result of this training, the (trained) AI model is configured to predict or recommend outcomes in response to an input of (unmodelled) data. Notably, as described further herein, the trained AI model is not a simple automation of existing claims handling process, but takes advantage of modern AI technologies to replicate the experience and knowledge typically only available to seasoned, expert claims handlers. By incorporating AI techniques into the model, the intricacies of causes, details, context, and outcomes can be leveraged to provide recommendations and responses to users without human intervention, in many cases.

In one exemplary embodiment, the user interfaces with the ACP computer device to provide information associated with the event and the resulting claim. Specifically, the ACP computer device is configured to generate a user interface that enables interaction with the ACP computer device at a remote computing device, for a user to access the functionality of the trained AI model. The user inputs initial data within this user interface. As described further herein, the ACP computer device is configured to recognize or determine that additional data is needed, applicable, and/or available. The ACP computer device generates and displays queries or prompts to the user, to request additional information from the user, and retrieves the additional information from various other data sources (e.g., upon permission and consent from the user). The ACP computer device may execute the trained AI model using the user input and additional data as inputs, and receive model output including a claim response. The claim response may include an approval of the claim, a denial of the claim, or an intermediate response, such as review by a human analyst.

In another exemplary embodiment, an agent of the insurance company interfaces with the ACP computer device during a claim processing or handling procedure after an event has occurred. It should be noted that the term “agent,” as used herein, is used broadly and does not necessarily refer to an “insurance agent,” in parlance, but rather to any person(s) acting on behalf of the insurance company, and may include an investigator, claims handler, “insurance agent,” third-party contracted agent, and the like. In these embodiments, the agent provides inputs to the ACP computer device during the claims handling procedure, to request verification of data or steps of the procedure, to request advice or interpretation of data, and the like. Similar to the above embodiment, the ACP computer device initiates a series of queries to receive data from the agent related to the event, and the ACP computer device, where necessary or applicable, retrieves additional data from one or more other data sources. The ACP computer device uses the user-input and additional data as model inputs to the trained AI model, and receives a model output responsive to the agent's initial query. The output may include, for example, a response to a question, a verification of a result, a recommendation of a next step in a procedure, etc.

The ACP computer device may be configured to automatically initiate various processes or functions in response to the model outputs. For example, where the model output is a recommendation that a claim be denied or forwarded to a human analyst, the ACP computer device may automatically (i) notify the user of this result and (ii) initiate the necessary or applicable functions, on the backend, to achieve the recommended result, including sending the claim (including the initial user-input data, the additional data, and the model output) to the human analyst or automatically denying the claim. Where the model output is a recommendation that a claim be approved, the ACP computer device may automatically (i) notify the user of this result and (ii) initiate the necessary or applicable functions, on the backend, to achieve the recommended result, including approving the claim, initiating a funds transfer associated with the claim, etc.

Additionally, the ACP computer device may be configured to store records of its processing. Specifically, the ACP computer device may be configured to store a record associated with the event or with the claim itself, where the record includes the event, the claim, the user-input data, the additional data, and the model output (or representations thereof). The ACP computer device may then store these records to re-train the AI model, as described herein, enabling continuous updating of the trained AI model. In at least some cases, the ACP computer device initially stores the record(s) in a first memory location associated with unverified records, and the record(s) must be verified (e.g., by a human auditor or using one or more automated verification devices and/or processes). Once a record is verified, the ACP computer device transfers the record to a second memory location, where it is stored and retrieved as part of the (updated) training set for the AI model. In some cases, the ACP computer device may not transfer or re-store the record but may add a flag indicating the record has been verified, or remove a flag indicated the record is unverified, for example, such that the record is automatically retrievable during subsequent re-training processes.

At least one of the technical benefits provided by the systems and method of the present disclosure may include: (i) improving speed and efficiency of processing an insurance claim; (ii) improving accuracy and reducing fraud (or buildup) on insurance claims; (iii) saving accurate and up-to-date records; (iv) iteratively storing and re-training models to provide consistent and robust results; (v) allowing access to a knowledge base typically reserved to specialists with years of experience, to novices and non-trained users; (vi) reducing human intervention in claims handling; (vii) enabling a centralized interface for accessing a networked system and centralizing access to disparate data sources; and (viii) automating claim responses.

The methods and systems described herein may be implemented (i) using computer programming or engineering techniques including computer software, firmware, hardware, or any combination or subset thereof, and/or (ii) by using one or more local or remote processors, transceivers, servers, sensors, servers, scanners, AR or VR headsets or glasses, smart glasses, and/or other electrical or electronic components, wherein the technical effects may be achieved by performing at least one of the following steps: 1) storing historical data in the at least one memory device, the historical data identifying a plurality of events, corresponding aspects associated with the events, and corresponding outcomes associated with the events; 2) training an artificial intelligence (AI) model using the historical data as a training set to generate a trained AI model that, when executed using unmodelled input data, is configured to output one or more predicted outcomes associated with the input data; 3) generating a user interface enabling access to functionality of the trained AI model at one or more remote computing devices; 4) receiving, via the user interface executed at a first remote computing device, an operational request including initial input data associated with a subject event; 5) identifying additional data missing from the operational request; 6) retrieving, in response to a plurality of queries and responses through the user interface, the additional data; 7) executing the trained AI model using the initial input data and the additional data, wherein a model output from the trained AI model includes an operational response to the operational request associated with the subject event; and 8) automatically initiating the operational response, including transmitting a notification of the operational response via the user interface and executing one or more functions responsive to the operational request using at least one of the initial input, the additional data, and the model output.

### Exemplary Processes for Training and Executing AI Models in Response to Operational Requests

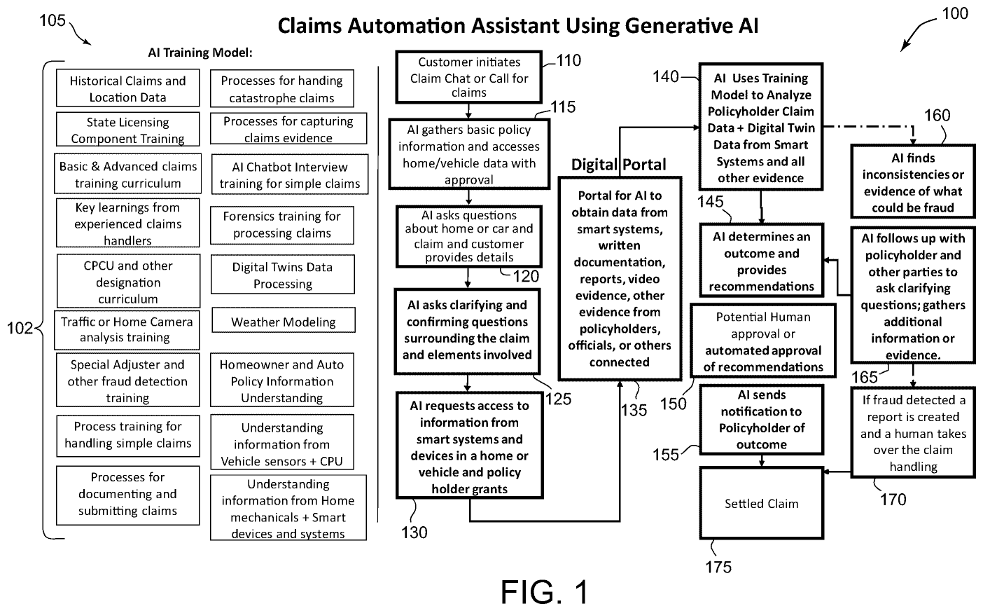

FIG. 1 illustrates a flow chart of an exemplary process 100 for training and executing artificial intelligence (AI) models in response to operational requests, in accordance with one embodiment of this disclosure.

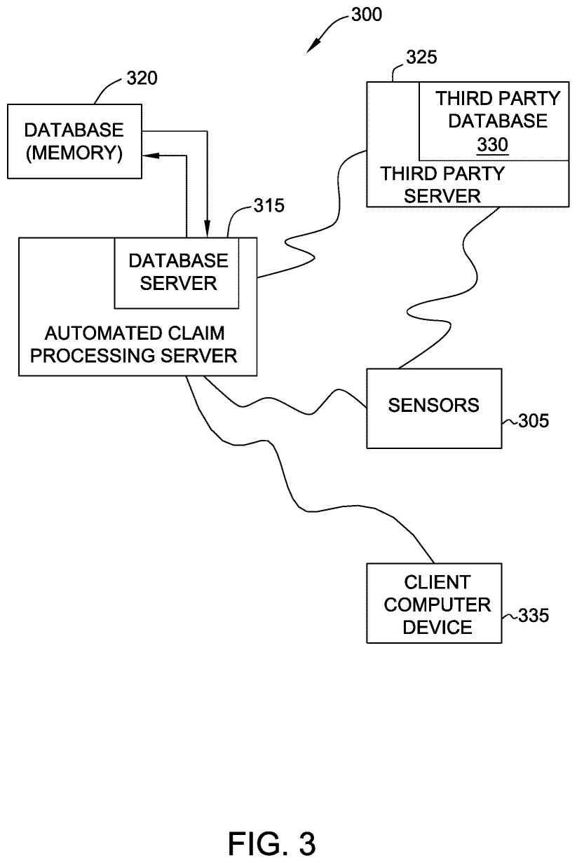

In the exemplary embodiment, process 100 may be performed by an automated claim processing (ACP) computer device, also known as an ACP server 310 (shown in FIG. 3). In the exemplary embodiment, ACP computer device 210 trains 105 an AI model using historical or stored data 102. Data 102 is broadly related to historical insurance claims and related events, the details thereof, and the outcomes of processing those claims.

An event could be any event that results in a loss for the policyholder that causes the policyholder to submit a claim. For example, the event may be a fire or storm damage to the policyholder's house or a vehicular accident, or any other type of loss.

In another instance, the loss could be a partial loss. For example, either where the policyholder's home is only partially damaged, or where the policyholder's vehicle was broken into, and several items were taken out of the vehicle.

Data 102 also includes contextual data associated with claims and events, as well as claims processing data, including steps and procedures for varying types of claims. The AI model may be, for example, a natural language model or some other type of machine learning (ML) model.

More particularly, data 102 may include historical claim data, including the details of the claim (e.g., type of event, amount claimed, type of covered property, etc.) as well as the location of the event and/or the covered property. This historical claim data may also include details regarding claim processing business and fraud detection practices. Data 102 may include state licensing data for one or more states in which ACP server 310 is accessible. State licensing data describes the requirements, by state, for how claims can be filed, how insurance functions to pay claims, and the like.

Data 102 also includes basic and advanced claims training curriculum. This curriculum is used in training of human claims handlers and, therefore, can also provide some level of learning to an AI model that incorporates natural language processes. Data 102 can include continuing education content and/or specialized certification content that is stored and/or updated periodically in response to relevant changes in the insurance field, such as in response to new technologies (e.g., electric vehicles, autonomous vehicles, etc.). Fraud training data and other specialized adjuster training may also be incorporated into data 102 used to train the AI model. Additionally, data 102 can include key learnings from experienced claims handlers, who may share their learnings for natural language processing by the AI model during training. These learning may be “rules of thumb,” for example, or trends or patterns noticed by experienced claims handlers that may not otherwise be incorporated into training or formalized knowledge bases.

In the exemplary embodiment, data 102 also includes process training for handling simple claims, documenting claims, submitting claims, handling catastrophe claims, and capturing claims evidence, as well as forensics training for processing claims. For example, but without limitation, this data 102 may include the types of documents needed or typically received, how to communicate documents across systems, what data is extracted from documents, how is the data applied to subsequent processing steps, how evidence is captured from sources other than the user, how to determine what additional documents or evidence are needed, etc. Certain types of claims may have more particular or detailed process flows associated therewith. Additionally, data 102 may include training or procedures for interviewing users, such as policyholders, to collect and share data. This data 102 may include the structuring of initial queries, follow-up queries, basic and complex responses, and the like.

Data 102 may also include completed analyses of images and/or videos, such as image/video content from traffic cameras, security cameras, home cameras, and the like. This data and its subsequent analysis provide to the AI model, once trained, the ability to interpret image/video content, such as determining what is shown and how it relates (or does not relate) to an event and a claim. Notably, the capacity to recognize what is evidence and what is not is an invaluable analysis skill that, once limited to experienced claims handlers, can be executable within a trained AI model.

Data 102 may include contextual data, including sensor or environmental data associated with covered property and/or the event. For instance, data 102 may include digital twin data from smart devices, smart appliances, smart sensors, or any other physical device generating contextual, operational, or usage data. As another example, data 102 may include weather data, including “raw” weather data, such as a sensed or recorded temperature, humidity, rainfall, etc. Weather data may also include predictive or historical weather modelling data.

Data 102 may include user and policy information as well. User information may include, for example, a user profile including biographical, demographic, device, location, and/or other data associated with a user (e.g., a policyholder or covered user). A user profile may also link to one or more insurance policies or claim histories. Policy information may include an identification of the covered property, the amount of coverage, coverage inclusions and exclusions, and the like.

Data 102 may include device or sensor information from devices/sensors at or associated with covered properties, or devices/sensors associated with user(s). Such devices or sensors may be further referred to generally as “sensors,” for the sake of brevity, and may include, for example but without limitation, vehicle sensors, smart home sensors, security systems, wearable devices, and the like.

In step 105, ACP server 310 collects available data 102 and formats data 102 as a training set for the AI model. In some instances, ACP server 310 performs various functions to label various portions of data 102 for the purposes of model training; in other instances, any labelling may have already been performed and is stored as part of data 102. ACP server 310 trains 105 the AI model using data 102 as known inputs. Therefore, the resulting trained AI model is configured to receive (unmodelled) inputs associated with insurance claims and related events and provide predicted or likely outcomes and/or recommendations for outcomes.

ACP server 310 may be configured to make the functionality of the trained AI model accessible to users by generating one or more user interfaces that can be executed on remote user computing devices. These user interfaces may include displayed user interfaces, such as those visually displayed on display devices, and/or audible user interfaces, such as those available by devices over cellular or other audio connections. In the context of process 100 depicted in FIG. 1, the user may be, generally, a policyholder, covered user, or person designated to control an insurance policy. In the content of process 200 depicted in FIG. 200, the user may be an agent or representative of the insurance company, such as an investigator or claims handler, for example.

In step 110, the user may initiate a session with ACP server 310, which may be a virtual chat session or a call session. The user may be initiating a claim or may identify an existing insurance claim. This initial request from the user is referred to herein as an operational request, the operation being some operation associated with the new or pending insurance claim.

ACP server 310 may gather 115 initial user input data, which may include basic policy information and/or user information as well as initial or preliminary information about the event. For example, the initial input data may include a policy number, a policyholder or user name, an address, and/or verification data (e.g., log-in credentials, a PIN, etc.) to verify the user is authorized to control the policy or claim. In the exemplary embodiment, ACP sever 310 executes an automated chatbot to gather 115 this information, within the user interface accessed by the user. In the exemplary embodiment, and with permission or consent from the user, ACP server 310 retrieves a user profile and/or insurance policy, using the initial input data.

ACP server 310 may be configured to recognize or determine that additional data will needed in order to continue the claims handling process. The additional data may be data related to the user, to the insurance policy, to the covered property, or, in many cases, to the event and the details surrounding the event. In some instances, ACP server 310 determines the additional data needed by attempting to execute the trained AI model, which, having insufficient data, may return an output indicating the model failed to execute and an identifier of data needed. In other instances, ACP server 310 may be configured to execute one or more preliminary data review processes to determine what additional data is needed. For example, if a certain type of claim is being initiated, ACP server 310 may determine that additional details relating to the nature of the event, the location of the event, the date of the event, etc., is needed before the claim can be processes.

ACP server 310 may be configured to retrieve, in response to a plurality of queries and responses through the user interface, the additional data. In particular, ACP server 310 may ask 120 questions about the covered property (e.g., a home or vehicle) and, in response, the user may provide details about the event. ACP server 310 may also ask 125 clarifying and/or confirming questions about the information provided and about other details or aspects of the event or the operational request. ACP server 310 may also request 130 permission or consent, from the user, to access additional information from devices or sensors associated with the user or covered property.

In some instances, ACP server 310 may identify which devices and/or sensors are associated with the covered property based upon information in the user profile and/or insurance policy. In other instances, as part of request 130, ACP server 310 may request details of the devices/sensors as well. For example, via a chatbot or an automated telephonic system, ACP server 310 may generate queries about the covered property (e.g., the home or vehicle) and receive responses from the user, such as “hail storm event; car was parked in driveway; hail damage to these areas of my car.” ACP server 310 may also generate verification queries that prompt the user to provide verifying information or evidence, such as sensor data.

ACP server 310 may also execute 135 a digital portal, which enables ACP server 310 to access information from third-party sources (e.g., via API connections, Matter Protocol connections, etc.). ACP server 310 may execute 135 the digital portal to access, for example, additional data from smart systems, written documentation, reports (e.g., police reports, medical reports, service reports), video evidence, and/or other evidence from policyholders, official sources, and/or other parties connected to or associated with covered property and/or the event.

ACP server 310 may identify, using information already provided by the user, relevant third parties that may have relevant evidence associated with the event. For example, in the case of a vehicular accident, ACP server 310 may identify relevant parties such as local community resources (e.g., traffic cameras), sensors from vehicles or building within the vicinity of the accident at the time of the accident, law enforcement or first responder resources, and the like. ACP server 310 may identify these relevant parties based upon location data or other sensor data, content extracted from documents (e.g., from a driver's license, from a police report or incident report, etc.), information input by the user in natural language (e.g., “John Doe was standing on the sidewalk and witnessed the event”; “The other car had the license plate 123 ABC”).

In some instances, ACP server 310 may execute or access the digital portal and the third-party resources in response to executing 140 the trained AI model, which may prompt ACP server 310 to gather additional information for the complete processing of the operational request. That is, in some instances, functions of the trained AI model and of data gathering may be connected or iterative.

ACP server 310 may execute the trained AI model by inputting 140 data for analysis thereby, including the initial input data from the user and any gathered additional data from the user and/or alternative data sources. The trained AI model, in response to the inputting, outputs 145 a model output that is responsive to the operational request and the input data. This output may be referred to as an operational response, and may including, in some instances, recommendations. The recommendation(s), in the exemplary embodiment, cause ACP server 310 to automatically execute 150 one or more functions related to the recommendation, such as automatically approving (or denying) the claim. ACP server 310 may also transmit 155 a notification of the operational response (e.g., the outcome or recommendation) back to the user, via the user interface with which the user is interacting with ACP server 310.

In some instances, the AI model may output 160 an indication of data inconsistencies or potential fraud. The operational response, therefore, may be for ACP server 310 to execute 165 remedial functions to collect additional data or request clarification or correction of previously gathered data. Additionally or alternatively, ACP server 310 may execute 170 remedial functions including forwarding the operational request (e.g., the claim at issue) to a human analyst for further review.

ACP server 310 may be further configured to generate 175 a record of the outcome of the operational request, that is, the operational response and any subsequent functions executed by ACP server 310 based thereon. In some instances, ACP server 310 stores the record and updates the training set with the record, to re-train the AI model using more current or up-to-date information. In some instance, the stored record must by verified (e.g., by a human auditor or by ACP server 310 or another computing device implementing data verification procedures) before the record is incorporated into the updated training set.

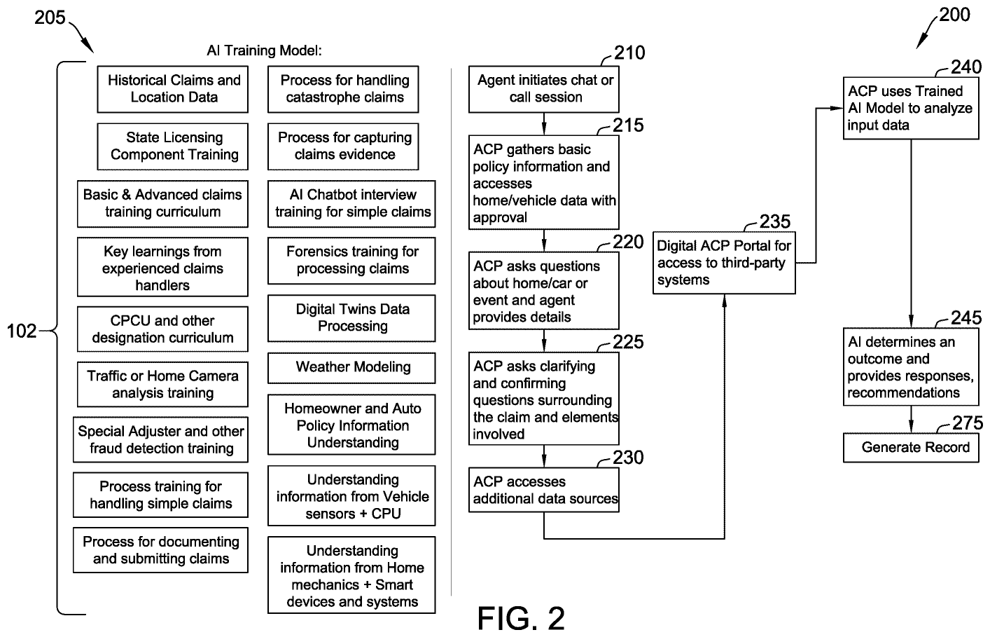

Turning to FIG. 2, an exemplary process 200 similar to process 100 is depicted. Process 200 is for training and executing artificial intelligence (AI) models in response to operational requests made by agent users, in accordance with one embodiment of this disclosure, as opposed to policyholder users. Notably, however, steps of process 200 may be similar to steps of process 100 and may therefore be discussed in less detail, where such detail has been provided above.

In the exemplary embodiment, process 200 may be performed by ACP server 310. In the exemplary embodiment, ACP computer device 310 trains 205 an AI model using historical or stored data 102. In step 210, the user—that is, the agent—initiates a session with ACP server 310. The session may be a virtual chat session or a call session and in some cases may include a video or image element, as described further herein. The agent may identify an existing insurance claim and one or more queries associated with the claim, such as requests for additional analysis or a recommendation of how to proceed with claim processing. This initial request from the agent is referred to herein as an operational request, the operation being some operation associated with review or processing of the pending insurance claim.

ACP server 310 may gather 215 initial user input data, which may include basic policy information and/or information about the policyholder as well as initial or preliminary information about the event. For example, the initial input data may include a policy number, a policyholder or user name, an address, and/or verification data (e.g., log-in credentials, a PIN, etc.) to verify the agent is authorized to review the policy or claim. In the exemplary embodiment, ACP sever 310 executes an automated chatbot to gather 215 this information, within the user interface accessed by the agent. In the exemplary embodiment, and with permission or consent from the policyholder, ACP server 310 retrieves a user profile and/or insurance policy, using the initial input data.

ACP server 310 may be configured to recognize or determine that additional data will needed in order to continue the claims handling process. The additional data may be data related to the policyholder, to the insurance policy, to the covered property, or, in many cases, to the event and the details surrounding the event. In some instances, ACP server 310 determines the additional data needed by attempting to execute the trained AI model, which, having insufficient data, may return an output indicating the model failed to execute and an identifier of data needed.

In other instances, ACP server 310 may be configured to execute one or more preliminary data review processes to determine what additional data is needed. For example, if a certain type of claim is being initiated, ACP server 310 may determine that additional details relating to the nature of the event, the location of the event, the date of the event, etc., is needed before the claim can be processes.

ACP server 310 may be configured to retrieve, in response to a plurality of queries and responses through the user interface, the additional data. In particular, ACP server 310 may ask 220 questions about the covered property (e.g., a home or vehicle) and, in response, the agent may provide details about the event. ACP server 310 may also ask 125 clarifying and/or confirming questions about the information provided and about other details or aspects of the event or the operational request. ACP server 310 may access 230 additional information from devices or sensors associated with the covered property. In some instances, ACP server 310 may identify which devices and/or sensors are associated with the covered property based upon information in the user profile and/or insurance policy. Information may be provided by the agent in the form of text-based responses, speech-based responses, and/or image/video-based responses. For example, the agent may provide an image or video captured using their user computing device (during or before the session) that depicts damage to the covered property or other environmental/contextual information associated with the event.

ACP server 310 may also execute 235 a digital portal, which enables ACP server 310 to access information from third-party sources, as described above. In some instances, ACP server 310 may execute or access the digital portal and the third-party resources in response to executing 240 the trained AI model, which may prompt ACP server 310 to gather additional information for the complete processing of the operational request. That is, in some instances, functions of the trained AI model and of data gathering may be connected or iterative.

ACP server 310 may execute the trained AI model by inputting 440 data for analysis thereby, including the initial input data from the agent and any gathered additional data from the agent and/or alternative data sources. The trained AI model, in response to the inputting, outputs 245 a model output that is responsive to the operational request and the input data. This output may be referred to as an operational response, and may including, in some instances, recommendations. The recommendation(s), in the exemplary embodiment, cause ACP server 310 to automatically execute one or more functions related to the recommendation, such as providing a response to the agent that is responsive to the agent's initial query. For example, where the agent asked for additional information associated with a particular type of damage to a covered property, and had provided image/video content, ACP server 310 may provide a response to the request as an informational overlap on the image/video content, or as a text-based response (or speech-based response). ACP server 310 may also transmits a notification of the operational response (e.g., the outcome or recommendation) back to the agent, via the user interface with which the agent is interacting with ACP server 310.

ACP server 310 may be further configured to generate 275 a record of the outcome of the operational request, that is, the operational response and any subsequent functions executed by ACP server 310 based thereon. In some instances, ACP server 310 stores the record and updates the training set with the record, to re-train the AI model using more current or up-to-date information. In some instance, the stored record must by verified (e.g., by a human auditor or by ACP server 310 or another computing device implementing data verification procedures) before the record is incorporated into the updated training set.

For illustrative purposes, an example is provided. An agent, such as a claims handler with little experience, is handling an insurance claim related to hail damage on the roof of a covered property. The agent is at the property and accesses the user interface to interact with ACP server 310, such as via a chatbot (e.g., within a messaging interface). The agent provides initial input data to the ACP server 310, such as the type of event, the time/date of the event, the location of the covered property, and details about the alleged damage to the roof. ACP server 310, in response, may present queries to the agent that prompt the agent to collect additional data, for example, image(s) of the alleged damage.

ACP server 310 may execute the trained AI model on any/all information provided by the agent, and may return recommendations in various formats. For example, ACP server 310 may generate and transmit an operational response that includes exemplary images or videos of verified damage that is ostensibly similar to the alleged damage in the claim. ACP server 310 may transmit text- or image-based instructions or recommendations about where to look for damage relative to the covered property. In some cases, the agent may activate an augmented reality feature of the user interface that enables the agent to provide a real-time video stream to ACP server 310 (and, thereby, for processing and interpretation by the trained AI model). ACP server 310 may use the model output to generate and transmit instructions or sample/exemplary images that are displayed as an overlay over the real-time video stream.

### Exemplary Computer Network

FIG. 3 depicts a simplified block diagram of an exemplary computer system 300 for implementing processes 100 and 200, respectively shown in FIGS. 1 and 2. In the exemplary embodiment, system 300 may be used for training and executing one or more AI models. System 300 includes ACP server 310, which is in communication with a plurality of sensors 305—which include individual or dedicated sensors as well as computing devices, such as smart home devices or connected vehicles, including such sensors—as well as one or more third-party computing devices (servers) 325 and one or more remote client computing device 335.

Sensors 305 are devices capable of sensing attributes of their environment. Sensors 305 may be a part of a vehicle, home, building, mobile device, virtual headset, and/or any other object that the sensors 305 may then provide the attributes of. For instance, sensors 305 may generate and collect data from several of the user's devices, such as the user's autonomous vehicle(s), smart vehicle, smart home controller, smart security systems, mobile devices, wearables, virtual headsets or smart glasses, family member devices, etc.

For instance, vehicle-based sensors may include navigation, communications, safety, security, and/or “infotainment” data. For example, vehicle telematics data collected may include, but is not limited to braking and/or acceleration data, navigation data, vehicle settings (e.g., seat position, mirror position, temperature, or air control settings, etc.), remote-unlock and/or remote-start data (e.g., determining which user computer device is used to unlock or start vehicle) and/or any other telematics data. The plurality of sensors 205 may also include sensors that detect conditions of vehicle, such as covered distance, speed, acceleration, gear, braking, cornering, and other conditions related to the operation of vehicle, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 305 may include impact sensors that detect impacts to vehicle, including force and direction and sensors that detect actions of vehicle, such the deployment of airbags. In some embodiments, sensors 305 may detect the presence of a driver and/or one or more passengers in a vehicle. In these embodiments, plurality of sensors 305 may detect the presence of fastened seatbelts, the weight in each seat in vehicle, heat signatures, or any other method of detecting information about driver and/or passengers in the vehicle.

In the case of property, such as, but not limited to, a home and/or a business property, sensors 305 may be deployed (and/or embedded) throughout the property. Sensors 305 may include, broadly, any kind of sensor (e.g., temperature, motion, sound/audio signal, light, etc.). In some embodiments, sensors 305 specifically include a smart thermostat. Sensors 305 may also include a home security system which may include security devices such as, for example, door or window sensors (e.g., to detect when doors or windows or open, when windows are broken), motion sensors (e.g., to detect when someone is present within range of the sensor), security cameras (e.g., for capturing audio/video of particular areas in or around the structure on the property, such as a doorbell camera), key pads (e.g., for enabling/disabling the security system), panic buttons (e.g., for alerting a security service or authorities of an emergency situation), security hubs (e.g., for integrating individual security devices into a security system, for centrally controlling such devices, for interacting with third parties), electric door locks, or smoke/fire/carbon monoxide detectors. Such “security devices” broadly represent devices that may detect potential contemporaneous risks to the property or its occupants (e.g., intrusion, fire, health).

In the exemplary embodiment, sensors 305 are enabled to transmit sensor data to ACP server 310 using the Internet. More specifically, sensors 305 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. In some embodiments, sensors 305 may be associated with any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bots, or other web-based connectable equipment or mobile devices.

In some embodiments, ACP server 310 may be associated with, or is part of a computer network associated with an insurance provider, or in communication with the insurance provider's computer network (not shown). In other embodiments, ACP server 310 may be associated with a third party and is merely in communication with the insurance provider's computer network.

A database server 315 may be communicatively coupled to a database 320 that stores data. In one embodiment, database 320 may store any of data 102 and any generated records. In the exemplary embodiment, database 320 may be stored remotely from ACP server 310. In some embodiments, database 320 may be decentralized.

One or more third-party computing devices or servers 325 may be communicatively coupled with ACP server 310. The one or more third-party servers 325 each may be associated with a third-party database 330. Third-party servers 325 may provide additional information to the ACP server 310. For example, third-party servers 325 may be associated with a different insurance provider. Third-party servers 325 may also be associated with other providers of information, such as, but not limited to, police departments, emergency medical providers, hospitals, and/or other third parties. In the exemplary embodiment, third-party servers 325 are computers that include a web browser or a software application, which enables third-party servers 325 to access ACP server 310 using the Internet. More specifically, third-party servers 325 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Third-party servers 325 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bots, or other web-based connectable equipment or mobile devices.

In the exemplary embodiment, client computer devices 335 are computers that include a web browser or a software application, which enables client computer devices 335 to access ACP server 310 using the Internet. More specifically, client computer devices 335 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client computer devices 335 may be any device capable of accessing the Internet including, but not limited to, a mobile device, a desktop computer, a laptop computer, a personal digital assistant (PDA), a cellular phone, a smartphone, a tablet, a phablet, wearable electronics, smart glasses, virtual headsets, smart watch, chat bots, or other web-based connectable equipment or mobile devices. In some embodiments, client computer devices 335 are capable of accessing information from or providing information to ACP server 310.

### Exemplary Server Device

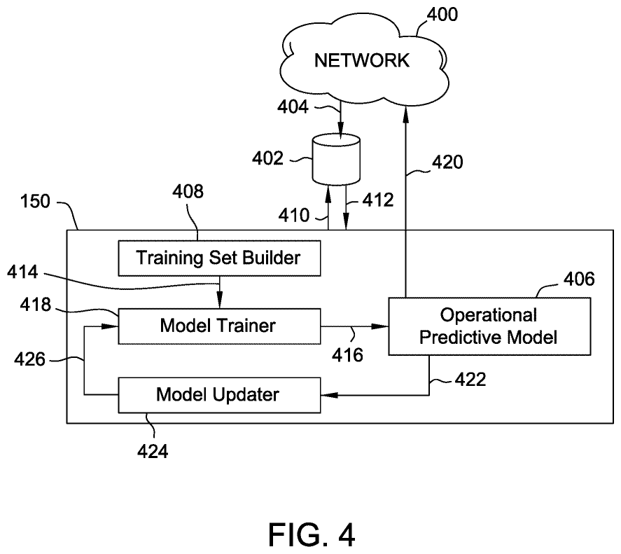

FIG. 4 is a schematic diagram illustrating further detail of exemplary server computing device 310 (shown in FIG. 3), such as an ACP server. Server computing device 310 may communicate with other components of system 300, such as third-party server 325, client computer devices 335, and/or sensor 305, via a network 400. Server computing device 310 may include and/or be in communication with a database 402 that stores data 404 including data 102 (as shown in FIGS. 1 and 2), stored records generated by ACP server 310, and/or any other relevant data s described herein. Data 404 received from network 400 may be stored in database 402. Server computing device 310 may configured to use data 404 to generate an operational predictive model module 406 for controlling operations of ACP server 310 (e.g., in accessing third-party databases via a digital portal), predicting outcomes of claims, generating action recommendations in response to operational requests, and the like.

In exemplary embodiments, server computing device 310 includes a training set builder module 408 configured to submit one or more queries 410 to database 402 to retrieve subsets 412 of data 404, and to use those subsets 412 to build training data sets 414 for generating operational predictive model 406. For example, query 410 may be configured to retrieve certain fields from data 404 for historical claims sharing characteristics, claims related to covered properties within a common geographic area, claims history for a user, and the like.

In exemplary embodiments, training set builder module 408 may be configured to derive training data sets 414 from retrieved subsets 412. Each training data set 414 corresponds to a historical data 404 (“historical” in this context means completed in the past, as opposed to completed in real-time with respect to the time of retrieval by training set builder module 122). Each training data set 414 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 414 may be generated from data fields in subset 412 corresponding to historical data 404. In other words, a trained machine learning model 416 produced by a model trainer module 418 for use by operational predictive model module 406 is trained to make predictions based on input values that can be generated from the data fields in data 404. Values in the model input data fields may include values copied directly from values in a corresponding data field in the retrieved subset 412, and/or values generated by modifying, combining, or otherwise operating upon values in one or more data fields in the retrieved subset 412. The use of such data fields as model input data fields facilitates the machine learning model in weighing these factors directly.

After training set builder module 408 generates training data sets 414, training set builder module 408 passes the training data sets 414 to model trainer module 418. In example embodiments, model trainer module 418 is configured to apply the model input data fields of each training data set 414 as inputs to one or more machine learning models. Each of the one or more machine learning models is programmed to produce, for each training data set 414, at least one output intended to correspond to, or “predict,” a value of the at least one result data field of the training data set 414. “Machine learning” refers broadly to various algorithms that may be used to train the model to identify and recognize patterns in existing data in order to facilitate making predictions for subsequent new input data.

Model trainer module 418 is configured to compare, for each training data set 414, the at least one output of the model to the at least one result data field of the training data set 414, and apply a machine learning algorithm to adjust parameters of the model in order to reduce the difference or “error” between the at least one output and the corresponding at least one result data field. In this way, model trainer module 418 trains the machine learning model to accurately predict the value of the at least one result data field. In other words, model trainer module 418 cycles the one or more machine learning models through the training data sets 414, causing adjustments in the model parameters, until the error between the at least one output and the at least one result data field falls below a suitable threshold, and then uploads at least one trained machine learning model 416 to operational predictive model module 406 for application to generating recommendations 420. In exemplary embodiments, model trainer module 418 may be configured to simultaneously train multiple candidate machine learning models and to select the best performing candidate for each result data field, as measured by the “error” between the at least one output and the corresponding result data field, to upload to operational predictive model module 406.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 418 cycles through the training data sets 414, model trainer module 418 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 418 provides an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

The ACP server 310 of the present disclosure is configured to operate on input data related to insurance claims and events, access additional data, and generate recommendations for response to the claims. In one exemplary embodiment, ACP server 310 executes the operational predictive model module 402 programmed to learn, without limitation, outcomes of claims based upon varying events and details, relevant data sources for evidence, the queries used to prompt a user to provide relevant information, features of claims or evidence related to potential fraud, and the like.

To facilitate this learning, ACP server 310 includes one or more databases 402 at which the data, including data 102 as well as responses, evidence, outcomes, etc., is stored. This data becomes one or more input training sets used by the training set builder 408. Model outputs can be formatted for presentation or review as visual representations of recommendations, as text-based or natural language recommendations, and the like. In exemplary embodiments, operational predictive model module 406 may compare feedback, and may route a comparison result 422 generated by comparing recommendation 420 to the feedback to a model updater module 424 of server computing device 310. Model updater module 424 is configured to derive a correction signal 426 from comparison results 422 received for one or more recommendations 220, and to provide correction signal 426 to model trainer module 418 to enable updating or “re-training” of the at least one machine learning model to improve performance. The retrained at least one machine learning model 416 may be periodically re-uploaded to operational predictive model module 406.

### Exemplary Server Device

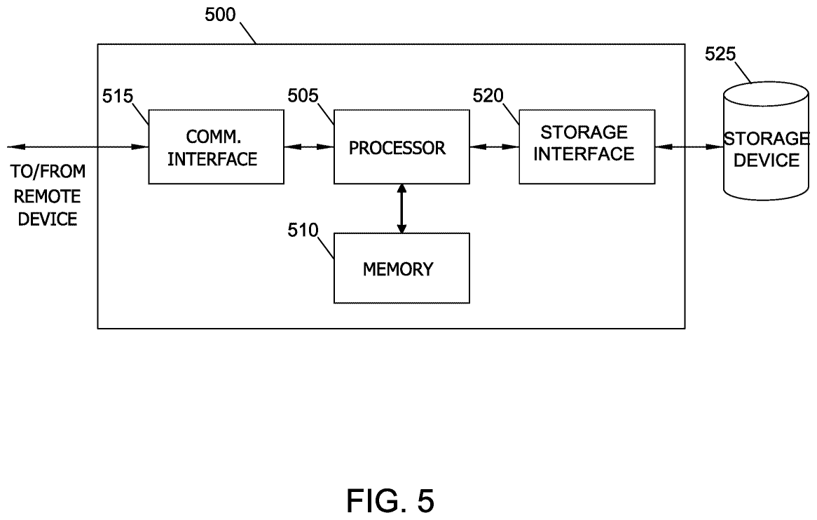

FIG. 5 depicts an exemplary configuration of a server computing device 500 such as ACP server 310 shown in FIG. 3, in accordance with one embodiment of the present disclosure. Server computer device 500 may include, but is not limited to, ACP server 310 and third-party servers 325 (all shown in FIG. 3). Server computer device 500 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 500 is capable of communicating with a remote device such as another server computer device 500, sensors 305, or client computer devices 335 (shown in FIG. 3). For example, communication interface 515 may receive requests from client computer devices 335 via the Internet, as illustrated in FIG. 3.

Processor 505 may also be operatively coupled to a storage device 525. Storage device 525 may be any computer-operated hardware suitable for storing and/or retrieving data, such as, but not limited to, data associated with database 320 or third-party database 330 (shown in FIG. 3). In some embodiments, storage device 525 may be integrated in server computer device 500. For example, server computer device 500 may include one or more hard disk drives as storage device 525.

In other embodiments, storage device 525 may be external to server computer device 500 and may be accessed by a plurality of server computer devices 500. For example, storage device 525 may include a storage area network (SAN), a network attached storage (NAS) system, and/or multiple storage units such as hard disks and/or solid-state disks in a redundant array of inexpensive disks (RAID) configuration.

In some embodiments, processor 505 may be operatively coupled to storage device 525 via a storage interface 520. Storage interface 520 may be any component capable of providing processor 505 with access to storage device 525. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 525.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instructions such as illustrated in FIGS. 1 and 2.

### Exemplary Client Device

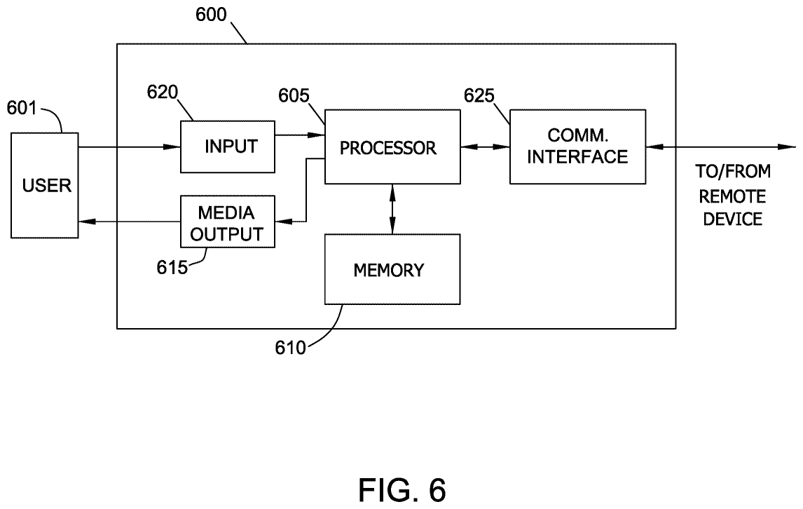

FIG. 6 depicts an exemplary configuration of a user computer device 600, such as client computer device 335 shown in FIG. 3, in accordance with one embodiment of the present disclosure. User computer device 600 may be operated by a user 601. User computer device 600 may include, but is not limited to, sensors 305 and client computer devices 335 (both shown in FIG. 3). User computer device 600 may include a processor 605 for executing instructions. In some embodiments, executable instructions are stored in a memory area 610. Processor 605 may include one or more processing units (e.g., in a multi-core configuration). Memory area 610 may be any device allowing information such as executable instructions and/or data (e.g., data 102) to be stored and retrieved. Memory area 610 may include one or more computer readable media.

User computer device 600 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets).

In some embodiments, media output component 615 may be configured to present a graphical user interface (e.g., a web browser and/or a client application) to user 601. A graphical user interface may include, for example, an interface for displaying queries and recommendations or outcomes. In some embodiments, user computer device 600 may include an input device 620 for receiving input from user 601. User 601 may use input device 620 to, without limitation, provide information in response to queries.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 600 may also include a communication interface 625, communicatively coupled to a remote device such as ACP server 310 (shown in FIG. 3). Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from ACP server 310. A client application allows user 601 to interact with, for example, ACP server 310. For example, instructions may be stored by a cloud service, and the output of the execution of the instructions sent to the media output component 615.

Processor 605 executes computer-executable instructions for implementing aspects of the disclosure. In some embodiments, the processor 605 is transformed into a special purpose microprocessor by executing computer-executable instructions or by otherwise being programmed.

### Exemplary Process for Training and Executing AI Models

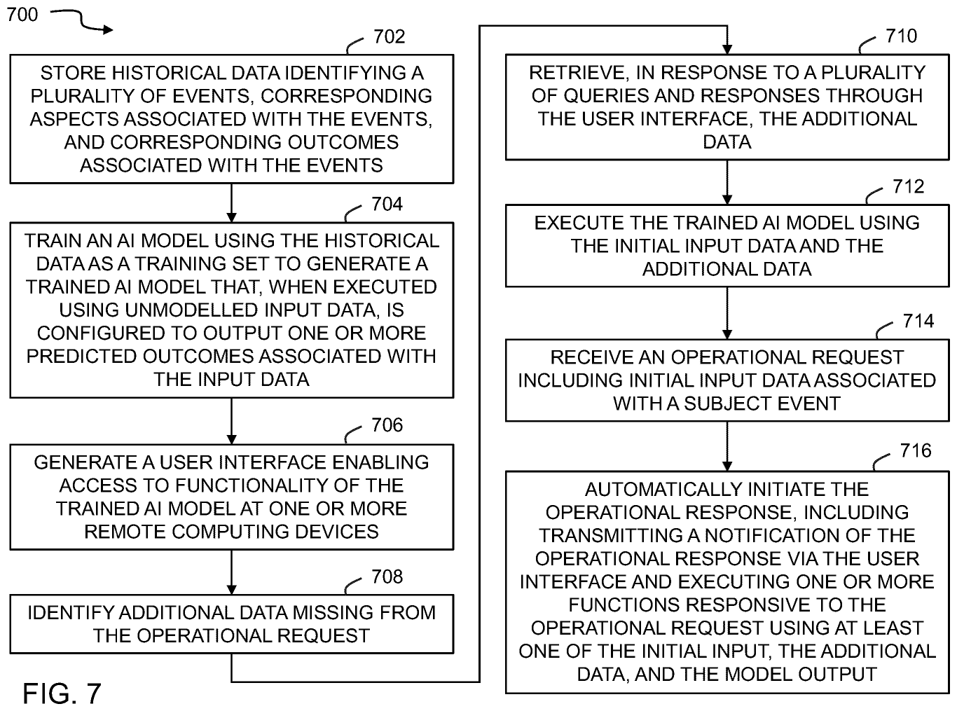

FIG. 7 illustrates a flow chart of an exemplary process 700 for training and executing artificial intelligence (AI) models, in accordance with one embodiment of this disclosure. FIG. 7 may be implemented using a computer system, such as, for example, ACP server 310 (shown in FIG. 3).

Process 700 may include storing 702 historical data in the at least one memory device. The historical data may identify a plurality of events, corresponding aspects associated with the events, and corresponding outcomes associated with the events. Process 700 may also include training 704 an AI model using the historical data as a training set to generate a trained AI model that, when executed using unmodelled input data, is configured to output one or more predicted outcomes associated with the input data.

Process 700 may further include generating 706 a user interface enabling access to functionality of the trained AI model at one or more remote computing devices, and receiving 708, via the user interface executed at a first remote computing device, an operational request including initial input data associated with a subject event.

Process 700 may include identifying 710 additional data missing from the operational request, and retrieving 712, in response to a plurality of queries and responses through the user interface, the additional data. Additionally, process 700 may include executing 714 the trained AI model using the initial input data and the additional data, wherein a model output from the trained AI model includes an operational response to the operational request associated with the subject event, and automatically initiating 716 the operational response, including transmitting a notification of the operational response via the user interface and executing one or more functions responsive to the operational request using at least one of the initial input, the additional data, and the model output.

Process 700 may include additional, fewer, and/or alternative steps, including those described elsewhere herein.

For example, in some embodiments, identifying 708 may include: (i) generating a query function using the initial input data; (ii) querying at least one data source using the query function; and/or (iii) in response to successfully querying the at least one data source, receiving a user profile associated with a user performing the operational request. Process 700 may further include recognizing, from the user profile, that additional data associated with the user profile is needed from the user to complete the operational request.

In some embodiments, process 700 may also include identifying the operational response as relating to potential fraud associated with the operational request, and initiating 716 may include executing a remedial function including transmitting the operational request and the output from the trained AI model to a human operator.

In some embodiments, the operational request may be associated with an insurance claim, the method further comprising identifying the operational response as a recommendation to complete the claim, and initiating 716 may include executing a settlement function including approving the insurance claim.

In some embodiments, the operational request is a request for assistance, and the plurality of queries and responses at the user interface include at least one query for contextual data and a related response from a user initiating the request for assistance. Process 700 may further include identifying the operational response as an assistive response responsive to the request for assistance, and wherein transmitting the notification may include transmitting a visual or audible response to the first remote computing device of the user. In some embodiments, executing one or more functions may include: (i) generating a record of the operational request and the operational response; and/or (ii) storing the record in the memory in a memory location associated with unverified data. In some embodiments, process 700 may include receiving an indication that the record has been verified, transferring the record to a second memory location associated with verified data, and/or incorporating the record into an updated training set for re-training the AI model.

In some embodiments, the operational request may be a request for assistance, the plurality of queries and responses at the user interface may include at least one query for contextual data and a related response from a user initiating the request for assistance. At least one related response may include an image or video captured in real-time at the first remote computing device of the user, process 700 may further include transmitting the notification of the operational response as an overlay on the image or video.

### Exemplary Embodiments & Functionality

In one embodiment, a computer system includes at least one processor in communication with at least one memory device. The at least one processor is programmed to: (i) store historical data in the at least one memory device, the historical data identifying a plurality of events, corresponding aspects associated with the events, and corresponding outcomes associated with the events; (ii) train an artificial intelligence (AI) model using the historical data as a training set to generate a trained AI model that, when executed using unmodelled input data, is configured to output one or more predicted outcomes associated with the input data; (iii) generate a user interface enabling access to functionality of the trained AI model at one or more remote computing devices; (iv) receive, via the user interface executed at a first remote computing device, an operational request including initial input data associated with a subject event; (v) identify additional data missing from the operational request; (vi) retrieve, in response to a plurality of queries and responses through the user interface, the additional data; (vii) execute the trained AI model using the initial input data and the additional data, wherein a model output from the trained AI model includes an operational response to the operational request associated with the subject event; and/or (viii) automatically initiate the operational response, including transmitting a notification of the operational response via the user interface and executing one or more functions responsive to the operational request using at least one of the initial input, the additional data, and the model output.

In some enhancements, the plurality of queries and responses at the user interface includes a first query requesting permission for the at least one processor to access a portion of the additional data and a first response granting the permission.

In some further enhancements, to identify the additional data missing from the operational request, the at least one processor may be further programmed to: (a) generate a query function using the initial input data; (b) query at least one data source using the query function; and (c) in response to successfully querying the at least one data source, receive a user profile associated with a user performing the operational request.

In some additional enhancements, the at least one processor may be further programmed to recognize, from the user profile, that additional data associated with the user profile is needed from the user to complete the operational request.

In some other enhancements, the at least one processor may be further programmed to identify the operational response as relating to potential fraud associated with the operational query. To automatically initiate the operational response, the at least one processor may be further programmed to execute a remedial function including transmitting the operational request and the output from the trained AI model to a human operator.

In other enhancements, the operational request may be associated with an insurance claim, wherein the at least one processor is further programmed to identify the operational response as a recommendation to complete the claim. To automatically initiate the operational response, the at least one processor is further programmed to execute a settlement function including approving the insurance claim.

In some embodiments, the operational request is a request for assistance, and the plurality of queries and responses at the user interface include at least one query for contextual data and a related response from a user initiating the request for assistance. In some additional enhancements, the at least one processor may be further programmed to identify the operational response as an assistive response responsive to the request for assistance. Transmitting the notification may include transmitting a visual or audible response to the first remote computing device of the user. In some enhancements, the executing one or more functions includes: (a) generating a record of the operational request and the operational response; and/or (b) storing the record in the memory in a memory location associated with unverified data. In some other enhancements, the at least one processor may be further programmed to: (1) receive an indication that the record has been verified; (2) transfer the record to a second memory location associated with verified data; and/or (3) incorporate the record into an updated training set for re-training the AI model.

In some other enhancements, at least one related response includes an image or video captured in real-time at the first remote computing device of the user. The at least one processor may be further programmed to transmit the notification of the operational response as an overlay on the image or video.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium. Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, ACP server 310 (shown in FIG. 3) is configured to implement machine learning, such that ACP server 310 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of device data, captured by a variety of connected home devices, and user data, related to a variety of host users and/or guest users, with known characteristics or features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

In one embodiment, a processing element may be trained by providing it with a large sample of conventional analog and/or digital, still and/or moving (i.e., video) image data, sensor data, telematics data, claims data, weather data, and/or other data of belongings, household goods, durable goods, appliances, electronics, homes, etc. with known characteristics or features. Based upon these analyses, the processing element may learn how to identify characteristics and patterns that may then be applied to analyzing sensor data, vehicle or home telematics data, image data, mobile device data, and/or other data.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is generally not intended to imply certain embodiments require at least one of X, at least one of Y, and at least one of Z to each be present. Additionally, conjunctive language such as the phrase “at least one of X, Y, and Z,” unless specifically stated otherwise, should be understood to mean any combination of at least one of X, at least one of Y, and at least one of Z.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system comprising at least one processor in communication with at least one memory device, the at least one processor programmed to:
store historical data in the at least one memory device, the historical data identifying a plurality of events, corresponding aspects associated with the events, and corresponding outcomes associated with the events;
train an artificial intelligence (AI) model using the historical data as a training set to generate a trained AI model that, when executed using unmodelled input data, is configured to output one or more predicted outcomes associated with the input data;
generate a user interface enabling access to functionality of the trained AI model at one or more remote computing devices;
receive, via the user interface executed at a first remote computing device, an operational request including initial input data associated with a subject event;
identify additional data missing from the operational request;
retrieve, in response to a plurality of queries and responses through the user interface, the additional data;
execute the trained AI model using the initial input data and the additional data, wherein a model output from the trained AI model includes an operational response to the operational request associated with the subject event; and
automatically initiate the operational response, including transmitting a notification of the operational response via the user interface and executing one or more functions responsive to the operational request using at least one of the initial input, the additional data, and the model output.

2. The computer system of claim 1, wherein the plurality of queries and responses at the user interface includes a first query requesting permission for the at least one processor to access a portion of the additional data and a first response granting the permission.

3. The computer system of claim 1, wherein to identify the additional data missing from the operational request, the at least one processor is further programmed to:
generate a query function using the initial input data;
query at least one data source using the query function; and
in response to successfully querying the at least one data source, receive a user profile associated with a user performing the operational request.

4. The computer system of claim 3, wherein the at least one processor is further programmed to recognize, from the user profile, that additional data associated with the user profile is needed from the user to complete the operational request.

5. The computer system of claim 1, wherein the at least one processor is further programmed to identify the operational response as relating to potential fraud associated with the operational request, and wherein to automatically initiate the operational response, the at least one processor is further programmed to execute a remedial function including transmitting the operational request and the output from the trained AI model to a human operator.

6. The computer system of claim 1, wherein the operational request is associated with an insurance claim, wherein the at least one processor is further programmed to identify the operational response as a recommendation to complete the claim, and wherein to automatically initiate the operational response, the at least one processor is further programmed to execute a settlement function including approving the insurance claim.

7. The computer system of claim 1, wherein the operational request is a request for assistance, and wherein the plurality of queries and responses at the user interface include at least one query for contextual data and a related response from a user initiating the request for assistance.

8. The computer system of claim 7, wherein the at least one processor is further programmed to identify the operational response as an assistive response responsive to the request for assistance, the transmitting the notification including transmitting a visual or audible response to the first remote computing device of the user.

9. The computer system of claim 8, wherein the executing one or more functions includes:
generating a record of the operational request and the operational response; and
storing the record in the memory in a memory location associated with unverified data.

10. The computer system of claim 9, wherein the at least one processor is further programmed to:
receive an indication that the record has been verified;
transfer the record to a second memory location associated with verified data; and
incorporate the record into an updated training set for re-training the AI model.

11. The computer system of claim 7, wherein at least one related response includes an image or video captured in real-time at the first remote computing device of the user, wherein the at least one processor is further programmed to transmit the notification of the operational response as an overlay on the image or video.

12. A computer-implemented method for training and executing an artificial intelligence (AI) model, the method implemented using an access management server computing device including at least one processor and at least one memory, the method comprising:
storing historical data in the at least one memory device, the historical data identifying a plurality of events, corresponding aspects associated with the events, and corresponding outcomes associated with the events;
training an AI model using the historical data as a training set to generate a trained AI model that, when executed using unmodelled input data, is configured to output one or more predicted outcomes associated with the input data;
generating a user interface enabling access to functionality of the trained AI model at one or more remote computing devices;
receiving, via the user interface executed at a first remote computing device, an operational request including initial input data associated with a subject event;
identifying additional data missing from the operational request;
retrieving, in response to a plurality of queries and responses through the user interface, the additional data;
executing the trained AI model using the initial input data and the additional data, wherein a model output from the trained AI model includes an operational response to the operational request associated with the subject event; and
automatically initiating the operational response, including transmitting a notification of the operational response via the user interface and executing one or more functions responsive to the operational request using at least one of the initial input, the additional data, and the model output.

13. The computer-implemented method of claim 12, wherein identifying the additional data missing from the operational request comprises:
generating a query function using the initial input data;
querying at least one data source using the query function; and
in response to successfully querying the at least one data source, receiving a user profile associated with a user performing the operational request.

14. The computer-implemented method of claim 13, further comprising recognizing, from the user profile, that additional data associated with the user profile is needed from the user to complete the operational request.

15. The computer-implemented method of claim 12, further comprising identifying the operational response as relating to potential fraud associated with the operational request, and
wherein automatically initiating the operational response comprises executing a remedial function including transmitting the operational request and the output from the trained AI model to a human operator.

16. The computer-implemented method of claim 12, wherein the operational request is associated with an insurance claim, the method further comprising identifying the operational response as a recommendation to complete the claim, and
wherein automatically initiating the operational response comprises executing a settlement function including approving the insurance claim.

17. The computer-implemented method of claim 12, wherein the operational request is a request for assistance, and wherein the plurality of queries and responses at the user interface include at least one query for contextual data and a related response from a user initiating the request for assistance,
the method further comprising identifying the operational response as an assistive response responsive to the request for assistance, and
wherein transmitting the notification comprises transmitting a visual or audible response to the first remote computing device of the user.

18. The computer-implemented method of claim 17, wherein the executing one or more functions comprises:
generating a record of the operational request and the operational response; and
storing the record in the memory in a memory location associated with unverified data.

19. The computer-implemented method of claim 18, further comprising:
receiving an indication that the record has been verified;
transferring the record to a second memory location associated with verified data; and
incorporating the record into an updated training set for re-training the AI model.

20. The computer-implemented method of claim 12, wherein the operational request is a request for assistance, wherein the plurality of queries and responses at the user interface include at least one query for contextual data and a related response from a user initiating the request for assistance, and at least one related response includes an image or video captured in real-time at the first remote computing device of the user, the method further comprising transmitting the notification of the operational response as an overlay on the image or video.
